(19) United States
(12) Patent Application Publication
(10) Pub. No.: US 2003/0191890 A1
(43) Pub. Date: Oct. 9, 2003

(54) Disk subsystem and a method for controlling the disk subsystem

(75) Inventors: Takeki Okamoto, Odawara (JP); Takao Satoh, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/223,828

(22) Filed: Aug. 19, 2002

(30) Foreign Application Priority Data
Apr. 8, 2002 (JP) 2002-104647

(51) Int. Cl. G06F 12/00

(52) U.S. Cl. 711/112; 711/113

(57) ABSTRACT

A plurality of magnetic disks are connected to a disk controller A through a fiber switch A and a fiber switch C. A disk controller B is connected to the plurality of magnetic disks through a fiber switch B and a fiber switch D. Access paths on the side of disk controller A and on the side of disk controller B are each interrupted by using associated fiber switches and a new disk controller is added between the fiber switches.

### CROSS-REFERENCE TO RELATED APPLICATIONS

The entire disclosure of Japanese Patent Application No. 2002-104647 filed on Apr. 8, 2002 by which the conventional right of priority of the present application is claimed is incorporated herein by reference.

### FIELD OF THE INVENTION

The present invention relates to a disk subsystem and more particularly, to a technique of adding a disk controller without stopping the system.

### BACKGROUND OF THE INVENTION

In recent years, a magnetic disk interface inside a disk subsystem has shifted, as a substitution for a conventional interface called SCSI, to an FC-AL interface operative at a higher speed and connectable with many devices. However, because of the ability to be connected with many devices, the throughput of paths as a whole is saturated as the number of devices increases.

U.S. Pat. No. 5,905,995 discloses a technique of achieving load balance in such an event by shifting data to a device associated with a path less loaded.

### SUMMARY OF THE INVENTION

In the case of the known system as above, however, much time is required for shifting of data.

In case a controller is added to cause the added controller to control part of devices with a view to decreasing the throughput of the whole of paths, it has hitherto been necessary to add the controller after stopping the system and update information about the construction of the system.

Stoppage of the system can be unneeded if the load balance is achieved by shifting data as described in U.S. Pat. No. 5,905,995 but conversely, much time is required to shift the data.

It is an object of the present invention to provide, in a disk control system for connecting a plurality of magnetic disk drives to a disk controller by means of FC-AL interfaces and controlling the plurality of magnetic disk drives, a technique of quickly adding a disk controller without stopping the system to improve the performance.

In a disk subsystem of the present invention, a plurality of magnetic disk drive groups are connected to two systems of access path and disk controller and each access path not only has a plurality of switch modules having the function to interrupt input/output of data to/from the disk drive group but also has the function to interrupt input/output of data between the switch modules.

In the aforementioned disk subsystem, after interrupting data input/output between the magnetic disk drives and between the switch modules by using switch modules associated with an access path on one side, a new disk controller is added between the switch modules, and switches that have been interrupted are reconnected. At that time, the construction information is changed in accordance with the addition of the controller. Further, a new disk controller is added to an access path on the other side through the same procedures, thereby ensuring that the new disk controllers can be added to the access paths associated with the magnetic disk drives without downing the system.

According to the disk subsystem of the invention, the new disk controllers can be added without stopping the system during system working to improve the performance.

Other objects, features and advantages of the invention will become apparent from the following description of the embodiments of the invention taken in conjunction with the accompanying drawings.

### BRIEF DESCRIPTION OF THE DRAWINGS

Preferred embodiments of the present invention will now be described in conjunction with the accompanying drawings, in which:

FIG. 1 is a conceptive diagram showing an example of the construction of a magnetic disk subsystem according to an embodiment of the invention;

FIG. 2 is a diagram showing an example of the construction subordinate to disk controllers in the FIG. 1 magnetic disk subsystem according to an embodiment of the invention.

FIG. 3 is a diagram useful to explain a process of adding a disk controller in the FIG. 2 embodiment of the invention.

FIG. 4 is a diagram useful to explain the disk controller adding process in the FIG. 2 embodiment of the invention.

FIG. 5 is a diagram useful in explaining the disk controller adding process in the FIG. 2 embodiment of the invention.

FIG. 6 is a diagram useful in explaining the disk controller adding process in the FIG. 2 embodiment of the invention.

FIG. 7 is a diagram useful in explaining the disk controller adding process in the FIG. 2 embodiment of the invention.

FIG. 8 is a diagram useful in explaining the disk controller adding process in the FIG. 2 embodiment of the invention.

FIG. 9 is a table showing an example of status type of disk controllers in the FIG. 2 embodiment of the invention.

FIG. 10 is a table showing an example of status type of disk controllers during the disk controller adding process in the FIG. 2 embodiment of the invention.

FIG. 11 is a table showing an example of status type of disk controllers during the disk controller adding process in the FIG. 2 embodiment of the invention.

FIG. 12 is a table showing an example of status type of disk controllers during the disk controller adding process in the FIG. 2 embodiment of the invention.

FIG. 13 is a table showing an example of status type of disk controllers during the disk controller adding process in the FIG. 2 embodiment of the invention.

FIG. 14 shows an example of a table of conversion between logical block position and physical block position in the FIG. 2 embodiment of the invention.

FIG. 15 shows an example of a logical block position-physical block position conversion table during the disk controller adding process in the FIG. 2 embodiment of the invention.

FIG. 16 shows an example of a logical block position-physical block position conversion table during the disk controller adding process in the FIG. 2 embodiment of the invention.

FIG. 17 is a flowchart of the disk controller adding process in the FIG. 2 embodiment of the invention.

### DESCRIPTION OF THE EMBODIMENTS

Embodiments of the invention will now be described in greater detail with reference to the accompanying drawings.

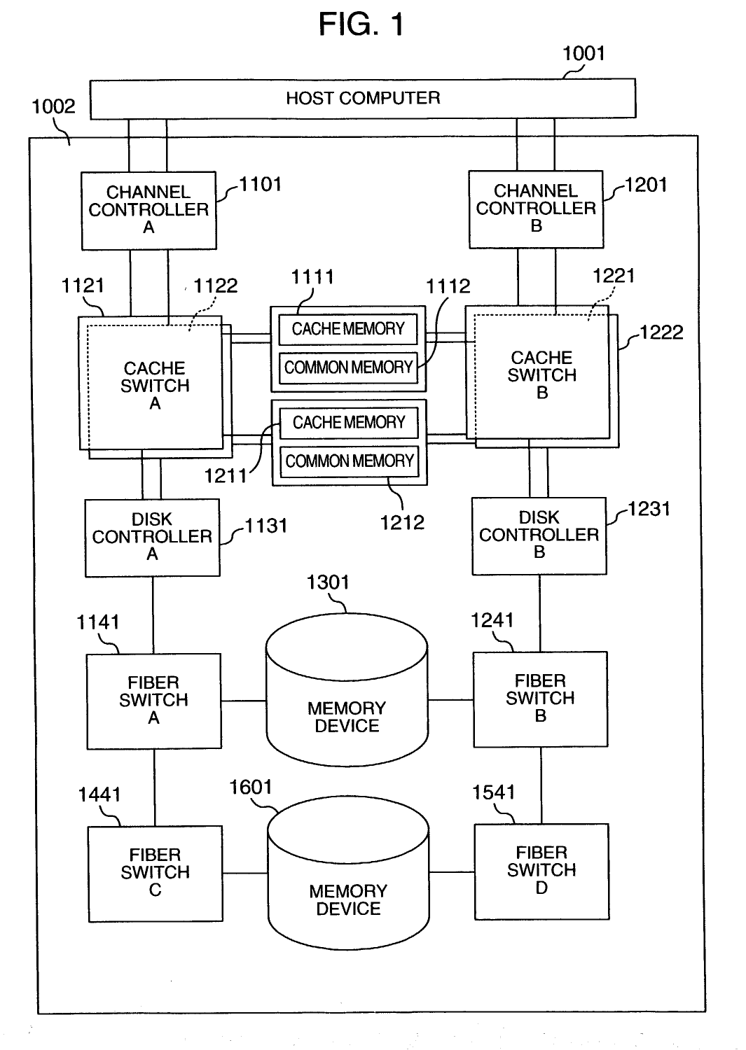

FIG. 1 shows the overall construction of a disk subsystem illustrative of an embodiment of the invention. A single pair of channel controller A 1101 and channel controller B 1201 are connected to a single host computer 1001 or a plurality of pairs of channel controller A 1101 and channel controller B 1201 are connected to a plurality of host computers 1001.

A single pair of disk controller A 1131 and disk controller B 1231 are connected to a single memory device 1301 through a fiber switch A 1141 and a fiber switch B 1241, respectively, or a plurality of pairs of disk controller A 1131 and disk controller B 1231 are connected to a plurality of memory devices 1301 through the respective fiber switches A 1141 and the respective fiber switches B 1241. The paired disk controller A 1131 and B 1231 are connected further to a single or a plurality of memory devices 1601 through a fiber switch C 1441 and a fiber switch D 1541, respectively, or through the respective fiber switches C 1441 and the respective fiber switches D 1541. Used as an input/output interface between the disk controller and the memory device is an FC-AL interface.

Input/output data transmitted/received to/from the host computer 1001 is temporarily stored in cache memories 1111 and 1211. Each of the cache memories 1111 and 1211 uses two planes to assure redundancy. The cache memories 1111 and 1211 are connected to the channel controller A 1101 through cache switches A 1121 and 1122. The cache memories 1111 and 1211 are also connected to the channel controller B 1201 through cache switches B 1221 and 1222. Further, the cache memories 1111 and 1211 are connected to the disk controller A 1131 through the cache switches A 1121 and 1122 and are connected to the disk controller B 1231 through the cache switches B 1221 and 1222.

Communication between the channel controller A 1101 and the disk controller A 1131 and that between the channel controller B 1201 and the disk controller B 1231 are carried out through common memories (shared memories) 1112 and 1212. The common memories 1112 and 1212 are connected to the channel controller A 1101 through the cache switches A 1121 and 1122 and are connected to the channel controller B 1201 through the cache switches 1221 and 1222. The common memories 1112 and 1212 are also connected to the disk controller A 1131 through the cache switches 1121 and 1122 and are connected to the disk controller B 1231 through the cache switches B 1221 and 1222.

When the channel controller A 1101 receives a data read request from the host computer 1001, it writes a command “read data from a block position (hereinafter referred to as a logical block) requested by the host computer and write the data in a cache” into the common memory 1112 or 1212 through the cache switch A 1121 or 1122. After the disk controller A 1131 or disk controller B 1231 has practiced conversion between logical block and physical block, it recursively monitors the common memories 1112 and 1212 to check if there is a command to input/output data to/from a memory device block position (hereinafter referred to as a physical block) connected to its own. When recognizing that the command “read data from a logical block requested by the host computer and write the data into a cache” is written in the common memory 1112 or 1212, the disk controller A 1131 or disk controller B 1231 carries out the logical-physical block conversion and confirms if an FC-AL interface connected to the memory device 1301 or 1601 described in the command is not registered as a blocked port in the common memory 1112 or 1212. In case the FC-AL interface is not registered as a blocked port, the disk controller A 1131 reads data from the memory device 1301 or 1601 through the fiber switch A 1141 or fiber switch C 1441 or the disk controller B 1231 reads data from the memory device 1301 or 1601 through the fiber switch B 1241 or fiber switch D 1541. The disk controller A 1131 writes the data into the cache memory 1111 or 1211 through the cache switch A 1121 or 1122 or the disk controller B 1231 writes the data into the cache memory 1111 or 1211 through cache switch B 1221 or 1222. Then, the disk controller A 1131 or disk controller B 1231 writes a “read end” report in the common memory 1112 or 1122 through the cache switch A 1121 or 1122 or the cache switch B 1221 or 1222. The channel controller A 1101 recursively monitors the common memories 1112 and 1212 through the cache switches A 1121 and 1122 to check if read operation ends. When recognizing that a “read end” report is described in the common memory 1112 or 1212, the channel controller A 1101 transfers the requested data stored in the cache memory 1111 or 1211 to the host computer 1001 through the cache switch A 1121 or 1122.

When the channel controller B 1201 receives a data write request from the host computer 1001, it writes data of the host computer 1001 into the cache memories 1111 and 1211 through the cache switches B 1221 and 1222. Thereafter, the channel controller B 1201 writes a command “data write” into the common memory 1112 or 1212 through the cache switch B 1221 or 1222. When the disk controller A 1131 or disk controller B 1231, which practices the logical-physical block conversion and thereafter recursively monitors the common memories to check if there is an input/output command to/from a physical block of a memory device connected to its own, recognizes that the “data write” command is written in the common memory 1112 or 1212, it reads data from the cache memory 1111 or 1211 through the cache switch A 1121 or 1122 or the cache switch B 1221 or 1222 and following the logical-physical conversion, confirms if an FC-AL interface connected to the memory device including the physical block is not registered as a blocked port. In case the interface of interest is not registered as a blocked port, the disk controller A 1131 or disk controller B 1231 writes the data into the memory device 1301 or 1601 through the fiber switch A 1141 or C 1441 or through the fiber switch B 1241 or D 1541.

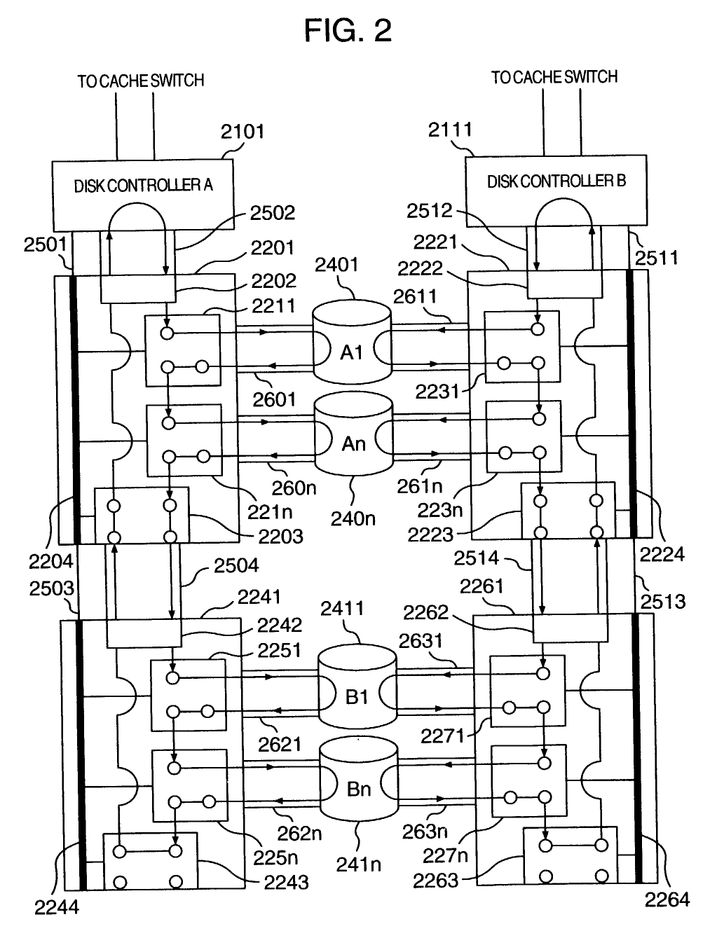

Referring to FIG. 2, part of the construction shown in FIG. 1 that is subordinate to a pair of disk controllers will be described.

A disk controller A 2101 is connected to an FC-AL interface connector 2202 of fiber switch 2201 through an FC-AL interface 2502 for performing paired one-way transmission. The fiber switch 2201 includes a single or a plurality of bypass switches 2211 to 221n which are connected to magnetic disks Al 2401 to An 240n, respectively, through FC-AL interfaces 2601 to 260n, respectively. The individual bypass switches 2211 to 221n are connected to a switching bus 2204. The disk controller A 2101 is connected to the switching bus 2204 through a switching bus interface 2501. The disk controller A 2101 controls the switching bus 2204 to change the bypass status of the bypass switches 2211 to 221n, thus making it possible to interrupt a signal flow to the FC-AL interfaces 2601 to 260n connected to the magnetic disks Al 2401 to An 240n. The fiber switch 2201 also includes a bypass switch 2203. With the bypass switch 2203 closed outward, the fiber switch 2201 can be connected to another fiber switch 2241 through an FC-Al interface 2504 and a switching bus interface 2503. The fiber switch 2241 includes a single or a plurality of bypass switches 2251 to 225n which are connected to magnetic disks B1 2411 to Bn 241n, respectively, through FC-AL interfaces 2621 to 262n. The individual bypass switches 2251 to 225n are connected to a switching bus 2244. The disk controller A 2101 is connected to the switching bus 2244 through the switching bus interface 2501, switching bus 2204 and switching bus interface 2503. The disk controller A 2101 controls the switching bus 2244 to change the bypass status of the bypass switches 2251 to 225n, thus making it possible to interrupt a signal flow to the FC-AL interfaces 2621 to 262n connected to the magnetic disks B1 2411 to Bn 241n. Similarly, a disk controller B 2111 is connected to an FC-AL interface connector 2222 of fiber switch 2221 through an FC-AL interface 2512 for paired one-way transmission. The fiber switch 2221 includes a single or a plurality of bypass switches 2231 to 223n which are connected to the magnetic disks Al 2401 to An 240n, respectively, through FC-AL interfaces 2611 to 261n, respectively. The individual bypass switches 2231 to 223n are connected to a switching bus 2224. The disk controller B 2111 is connected to the switching bus 2224 through a switching bus interface 2511. The disk controller B 2111 changes the bypass status of the bypass switches 2231 go 223n, thus making it possible to interrupt a signal flow to the FC-AL interfaces 2611 to 261n connected to the magnetic disks Al 2401 to An 240n. The fiber switch 2221 also includes a bypass switch 2223 and with this bypass switch closed outward, the fiber switch 2221 can be connected to another fiber switch 2261 through an FC-AL interface 2514 and a switching bypass interface 2262. The fiber switch 2261 includes a single or a plurality of bypass switches 2271 to 227n which are connected to the magnetic disks B1 2411 to Bn 241n, respectively, through FC-AL interfaces 2631 to 263n, respectively. The individual bypass switches 2271 to 227n are connected to a switching bus 2264. The disk controller B 2111 is connected to the switching bus 2264 through the switching bus interface 2511, switching bus 2224 and switching bus interface 2513 and it changes the bypass status of the bypass switches 2271 to 227n so as to make it possible to interrupt a signal flow to the FCAL interfaces 2631 to 263n connected to the magnetic disks B1 2411 to Bn 241n.

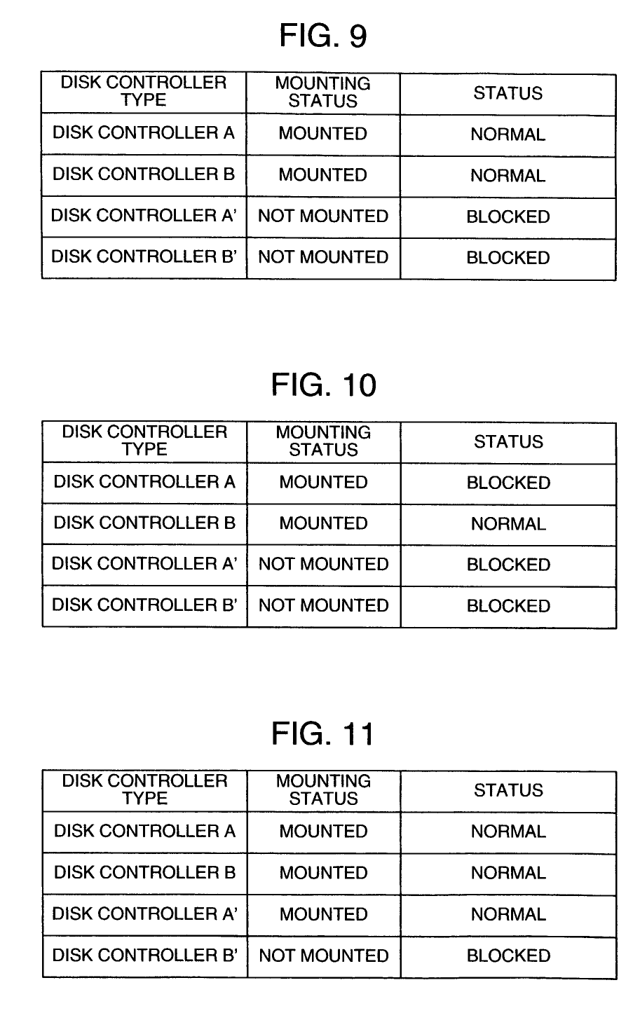

Referring to FIG. 9, there is illustrated control information indicative of status information for each disk controller. The control information includes mounting information as to whether the disk controller is mounted and status indicative of the operating status and is stored in the common memories 1112 and 1212 shown in FIG. 1. In the construction status of FIG. 2, the disk controller A is mounted to exhibit normal status, the disk controller B is also mounted to exhibit normal status, a disk controller A′ is not mounted to exhibit blocked status and a disk controller B′ is not mounted to exhibit blocked status.

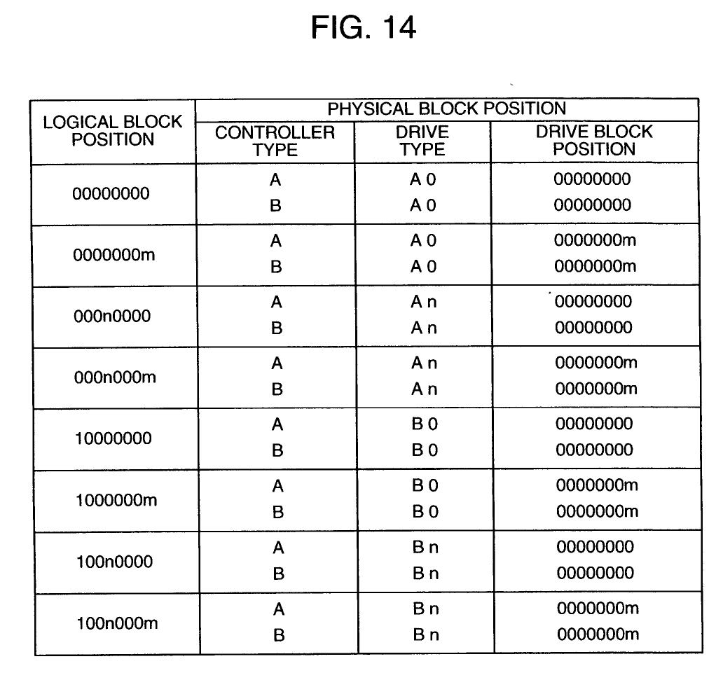

Referring to FIG. 14, there is illustrated an example of a table for conversion between logical block position and physical block position in the construction status of FIG. 2. The present table is stored in the common memories 1112 and 1212 shown in FIG. 1.

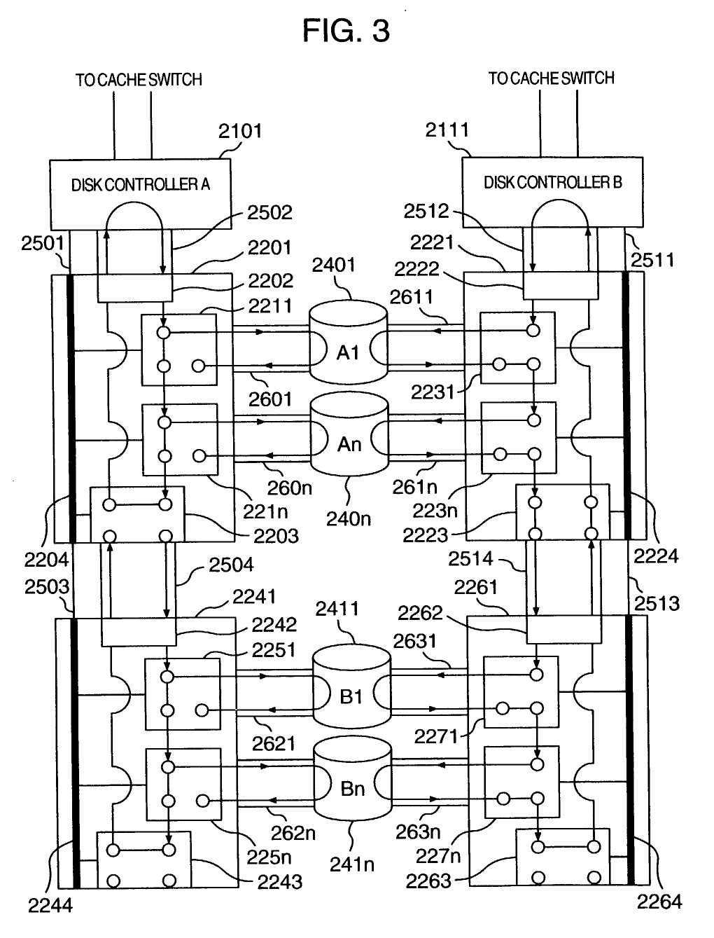

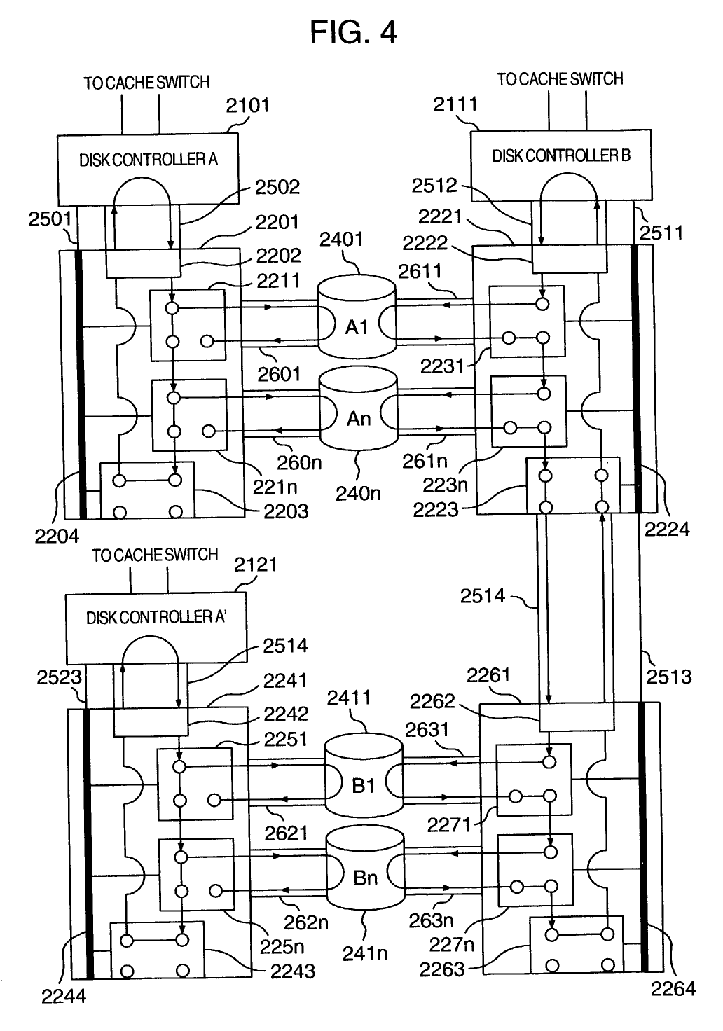

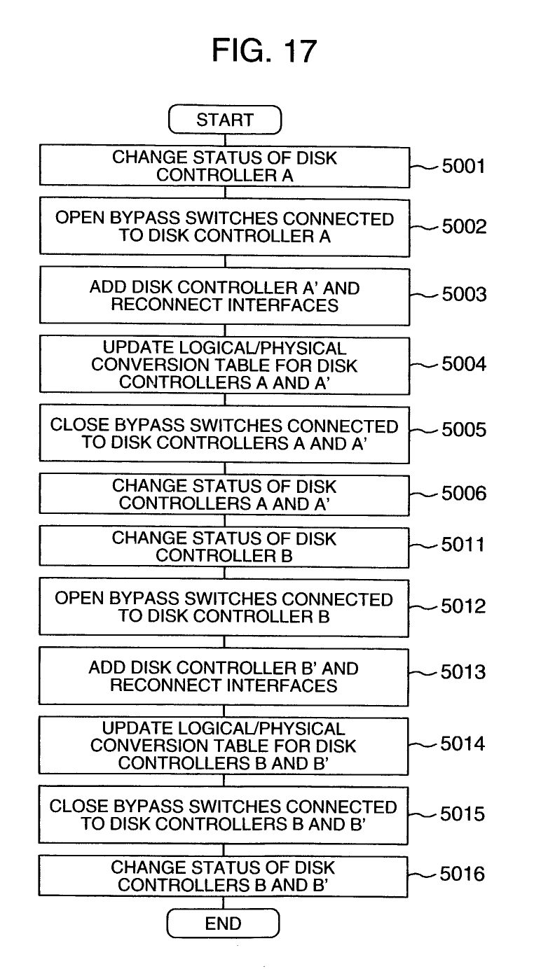

Referring to FIG. 17, there is illustrated a flowchart showing the sequence of maintenance operation for adding a controller to a drive in operation. Firstly, in step 5001, the status of disk controller A 2101 stored in the common memories 1112 and 1212 is changed to “mounted-blocked” as shown in FIG. 10 to prevent the disk controller A 2101 side from receiving an I/O request. Next, in step 5002, the bypass switches 2211 to 221n and 2251 to 225n are opened as shown in FIG. 3 to interrupt signals from the drive A1 2401 to drive An 240n and from the drive B1 2411 to drive Bn 241n and the fiber switch 2203 is closed inward to interrupt signals between the fiber switch 2241 and the fiber switch 2201. Then, in FIG. 3, the switching bus interface 2503 and FC-AL interface 2504 are removed in the step 5002, and a disk controller A′ 2121 shown in FIG. 4 is added and connected to the fiber switch 2241 by using a switching bus interface 2523 and an FC-AL interface 2524 (step 5003).

In case the fiber switch 2241 has the function to connect two systems of disk controller or fiber switch, only a disk controller of one system may be connected and in this construction, input/output of data transfer to/from the plurality of memory devices A and the plurality of memory devices B may be interrupted by means of a switch circuit and thereafter, a controller of the other system may be connected, thereby completing addition of the disk controllers.

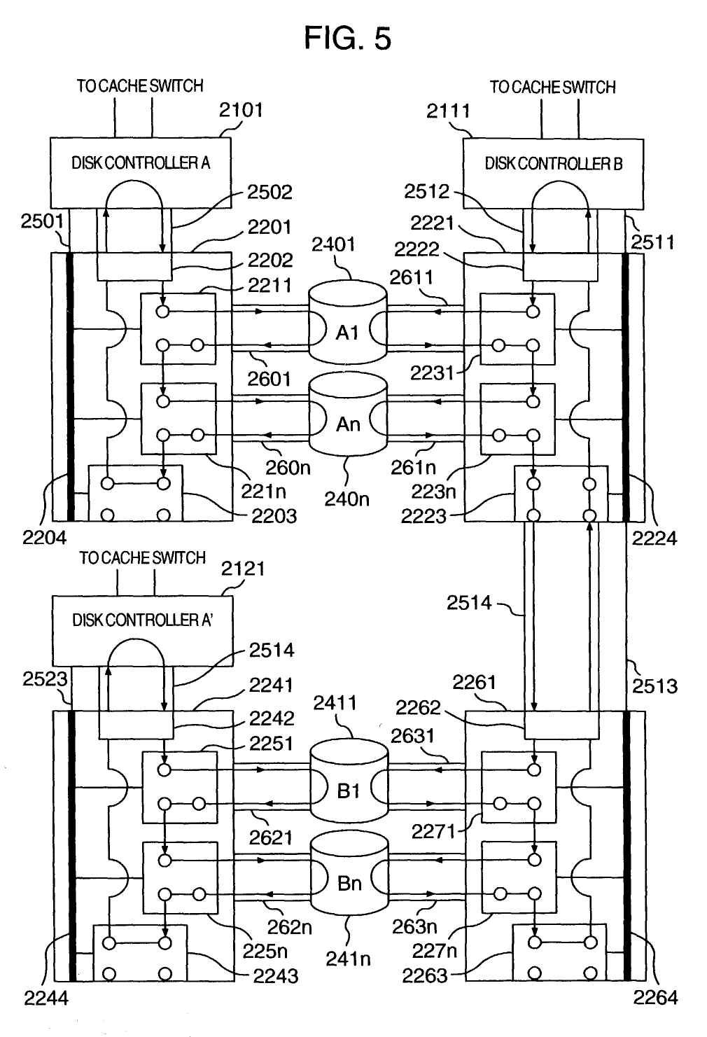

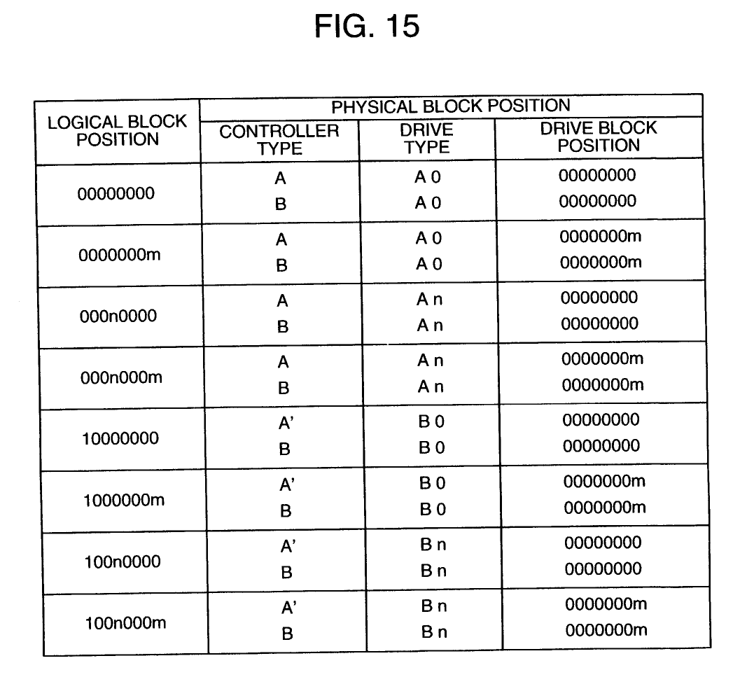

Subsequently, in step 5004, the logical block position-physical block position conversion table stored in the common memories 1112 and 1212 is updated as shown in FIG. 15 in order that the controller type corresponding to logical block positions 10000000 to 1000000m and 100n0000 to 100n000m can be changed from A to A′. Then, in step 5005, the fiber switches 2211 to 221n and fiber switches 2251 to 225n are closed as shown in FIG. 5 to release the bypasses associated with the drive A1 2401 to An 240n and the B1 2411 to Bn 141n. Thereafter, in step 5006, the attribute of the controller A 2101 stored in the common memories 1112 and 1212 of FIG. 1 is changed to “mounted-normal” as shown in FIG. 11 and the status of the controller A′ 2121 is changed to “mounted-normal”, thereby placing the controller A and controller A′ in usable condition.

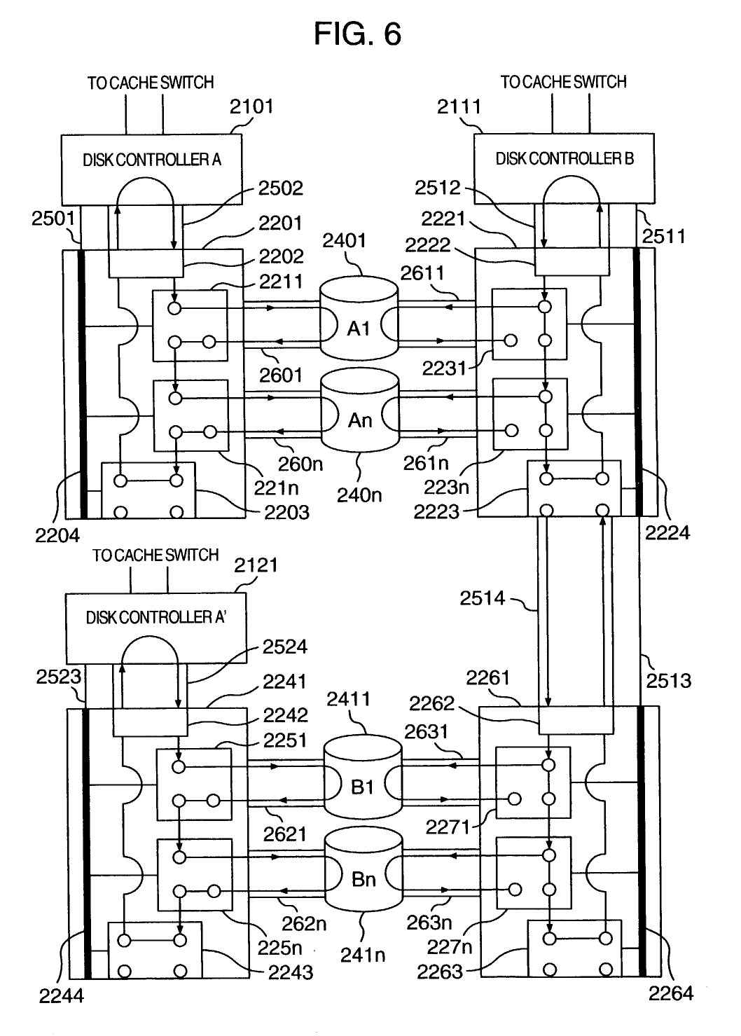

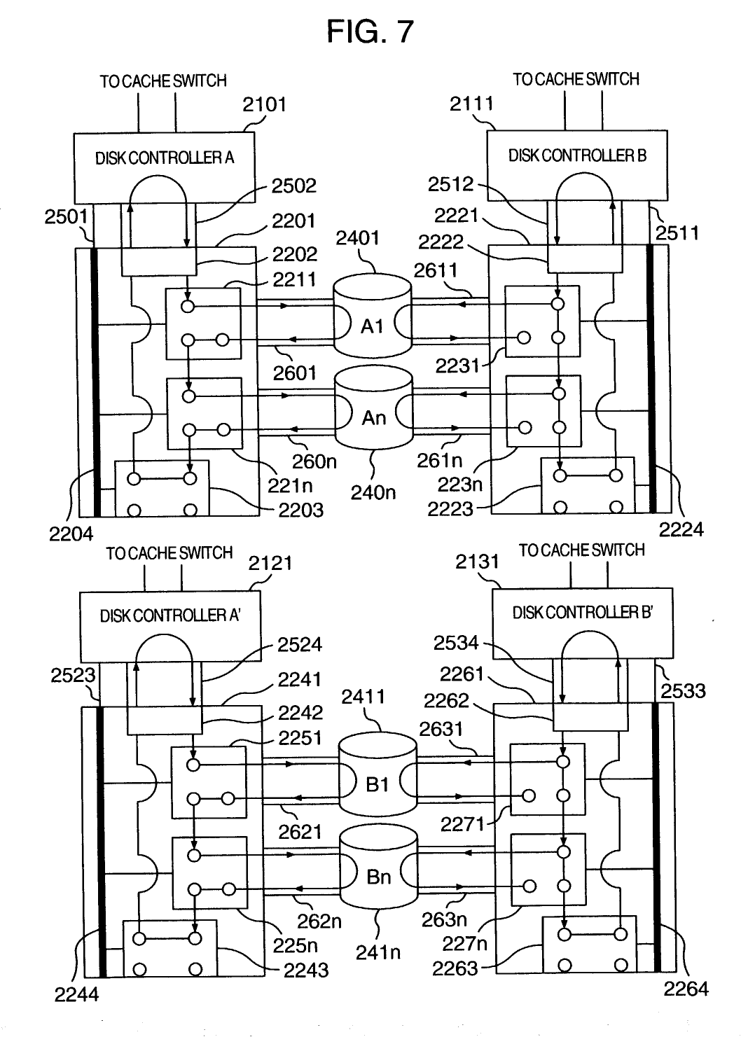

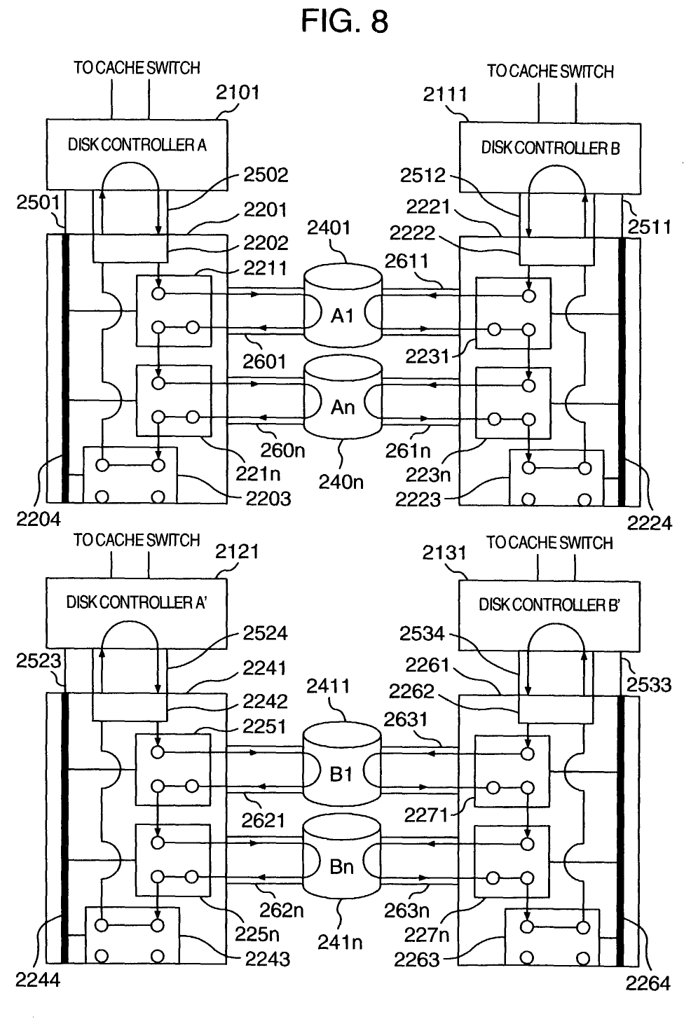

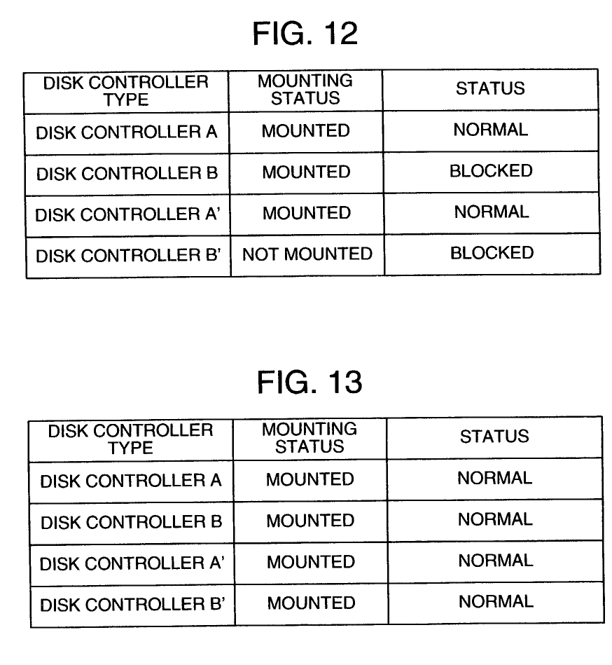

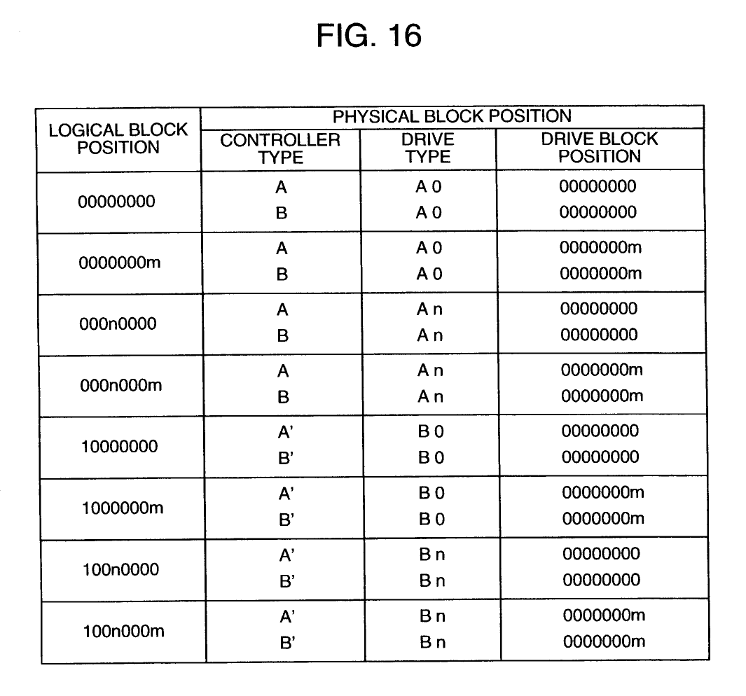

Next, in step 5011, the status of disk controller B 2111 stored in the common memories 1112 and 1212 is changed to “mounted-blocked” as shown in FIG. 12. Then, in step 5012, the bypass switches 2231 to 223n and 2271 to 227n are opened as shown in FIG. 6 to interrupt signals to/from the drives A1 2401 to An 240n and B1 2411 to Bn 241n and the fiber switch 2223 is closed inward to interrupt signals between the fiber switch 2221 and the fiber switch 2261. Thereafter, in the step 5012, the switching bus interface 2513 and FC-AL interface 2514 are removed in FIG. 6, and a disk controller B′ 2131 shown in FIG. 7 is added and connected to the fiber switch 2261 by using a switching bus interface 2533 and an FC-AL interface 2534 (step 5013). At that time, if the fiber switch 2261 has the function to connect two systems of disk controller or fiber switch, only a controller of one system may be connected and in this construction, input/output of data transfer to/from the plurality of memory devices A and the plurality of memory devices B may be interrupted by means of a switch circuit and thereafter, a controller of the other system may be connected, thus completing the addition of the disk controllers. Next, in step 5014, the logical block position-physical block position conversion table stored in the common memories 1112 and 1212 shown in FIG. 1 is updated as shown in FIG. 16 in order that the controller type corresponding to logical block positions 10000000 to 1000000m and 100n0000 to 100n000m is changed from B to B′. Subsequently, in step 5015, the fiber switches 2231 to 223n and fiber switches 2271 to 227n are closed as shown in FIG. 8 to release the bypasses for the drive A1 2401 to An 240n and B1 2411 to Bn 241n. Then, in step 5016, the status of controller B 2111 stored in the common memories of FIG. 1 is changed to “mounted-normal” and the status of controller B′ 2131 is changed to “mounted-normal”, thus placing the controller B and controller B′ in usable condition.

It should be further understood by those skilled in the art that although the foregoing description has been made on embodiments of the invention, the invention is not limited thereto and various changes and modifications may be made without departing from the spirit of the invention and the scope of the appended claims.

1. A disk subsystem comprising:
a plurality of first and second memory devices for storing data;
first and second disk controllers for controlling said plurality of first and second memory devices;
a cache memory for temporarily holding data to be stored in said plurality of first and second memory devices;
a common memory for storing control information having mounting status information and operating status information concerning said first and second disk controllers;
first and second channel controllers connected to a host computer to control input/output interfaces to/from said host computer;
a first cache switch connected to said first disk controller, cache memory, common memory and first channel controller;
a second cache switch connected to said second disk controller, cache memory, common memory and second channel controller;
a first switch circuit connected to one of said plurality of first memory devices and said first disk controller;
a third switch circuit connected to one of said plurality of second memory devices and said first switch circuit;
a second switch circuit connected to said first one of said plurality of memory devices and said second disk controller;
a fourth switch circuit connected to said second one of said plurality of memory devices and said second switch circuit; and
a third disk controller to be added to said third switch circuit during working of said disk subsystem.

2. A disk subsystem according to claim 1, wherein with said third disk controller added, said operating status information of said third disk controller is set.

3. A disk subsystem according to claim 2, wherein when said operating status information of said first disk controller is changed to information indicative of blocking and said first disk controller stops receiving an access request from said host computer, said third disk controller makes ready for its addition to said disk subsystem.

4. A disk subsystem according to claim 3, wherein when disconnecting said first switch circuit from said third switch circuit and connecting said third disk controller to said third switch circuit, said mounting status information of said third disk controller is set with information indicative of mounting and said operating status information of said third disk controller is set with information indicative of normal to let said third disk controller usable in said disk subsystem.

5. A disk subsystem according to claim 4, wherein when said first switch circuit and said third switch circuit stop interchanging signals to/from said plurality of first and second memory devices, signal interchange between said first switch circuit and said third switch circuit is stopped, said first switch circuit is disconnected from said third switch circuit, said third disk controller is connected to said third switch circuit and then said first switch circuit and said third switch circuit start to interchange signals to/from said plurality of first and second memory devices, thereby completing connection of said third disk controller to said third switch circuit.

6. A disk subsystem according to claim 5 further comprising:
a first inter-switch interface used for interchange of signals between said first switch circuit and said third switch circuit; and
a second inter-switch interface used for interchange of data between said first switch circuit and said third switch circuit, wherein
said third switch circuit has the function to connect two systems of disk controller or switch circuit;
said third switch circuit is connected to said first switch circuit and third disk controller;
said first inter-switch interface is used for disconnecting said first switch circuit from said third switch circuit; and
said second inter-switch interface is connected to said third disk controller so as to be used for interchanging data to/from said third disk controller.

7. A disk subsystem according to claim 4, wherein when said operating status information of said second disk controller is changed to information indicative of blocking and said second disk controller stops receiving an access request from said host computer, a fourth disk controller makes ready for addition to said disk subsystem.

8. A disk subsystem according to claim 7, wherein when disconnecting said second switch circuit from said fourth switch circuit and connecting said fourth disk controller to said fourth switch circuit, said mounting status information of said fourth disk controller is set with information indicative of mounting and said operating status information of said fourth disk controller is set with information indicative of normal to thereby let said fourth disk controller usable in said disk subsystem.

9. A disk subsystem according to claim 8, wherein said second switch circuit and said fourth switch circuit stop interchanging signals to/from said plurality of first and second memory devices, signal interchange between said second switch circuit and said fourth switch circuit is stopped, said second switch circuit is disconnected from said fourth switch circuit, said fourth disk controller is connected to said fourth switch circuit and said second switch circuit and said fourth switch circuit start interchanging signals to/from said plurality of first and second memory devices, thereby completing connection of said fourth disk controller to said fourth switch circuit.

10. A disk subsystem according to claim 9 further comprising:
a third inter-switch interface used for interchanging signals between said second switch circuit and said fourth switch circuit; and
a fourth inter-switch interface used for interchanging data between said second switch circuit and said fourth inter-switch interface, wherein
said fourth switch circuit has the function to connect two systems of disk controller or switch circuit;
said fourth switch circuit is connected to said second switch circuit and fourth disk controller;
said third inter-switch interface is used for disconnecting said second switch circuit from said fourth switch circuit; and
said fourth inter-switch interface is connected to said fourth disk controller so as to be used for interchange of data to/from said fourth disk controller.

11. A method for controlling a disk subsystem having a plurality of first and second memory devices, first and second disk controllers for controlling said plurality of first and second memory devices, a cache memory for temporarily holding data to be stored in said plurality of first and second memory devices, a common memory for storing control information, first and second channel controllers connected to a host computer to control input/output interfaces to/from said host computer, a first cache switch connected to said first disk controller, cache memory, common memory, and first channel controller, a second cache switch connected to said second disk controller, cache memory, common memory and second channel controller, a first switch circuit connected to one of said plurality of first memory devices and said first disk controller, a third switch circuit connected to one of said plurality of second memory devices and said first switch circuit, a second switch circuit connected to said one of said plurality of first memory devices and said second disk controller, and a fourth switch circuit connected to said one of said plurality of second memory devices and said second switch circuit, said method comprising the steps of:
blocking said first disk controller in accordance with said control information;
changing connection of said first switch circuit and said third switch circuit to connection of said third switch circuit and a third disk controller to be connected to said first cache switch;
releasing said first disk controller from blocking in accordance with said control information; and
placing said third disk controller in usable condition in accordance with said control information.

12. A disk subsystem controlling method according to claim 11, wherein the step of blocking said first disk controller includes the steps of:
causing said first disk controller to stop receiving an access request from said host computer; and
disconnecting said first switch circuit from said third switch circuit.

13. A disk subsystem controlling method according to claim 12, wherein the step of disconnecting said first switch circuit from said third switch circuit includes the steps of:
causing said first switch circuit and said third switch circuit to stop input/output of signals to/from said plurality of first and second memory devices;
causing said first switch circuit and said third switch circuit to stop interchange signals therebetween; and
disconnecting said first switch circuit from said third switch circuit.

14. A disk subsystem controlling method according to claim 11, wherein the step of changing connection of said first switch circuit and said third switch circuit to connection of said third switch circuit and a third disk controller to be connected to said first cache switch includes the steps of:
connecting said third disk controller to said third switch circuit;
changing said control information; and
causing said first switch circuit and said third switch circuit to start interchange of signals to/from said plurality of first and second memory devices.

15. A disk subsystem controlling method according to claim 11, wherein the step of blocking said second disk controller in accordance with said control information includes the steps of:
changing connection of said second switch circuit and said fourth switch circuit to connection of said fourth switch circuit and a fourth disk controller to be connected to said second cache switch;
releasing said second disk controller from blocking in accordance with said control information; and
placing said fourth disk controller in usable condition in accordance with said control information.

16. A disk subsystem controlling method according to claim 15, wherein the step of blocking said second disk controller includes the steps of:
causing said second disk controller to stop receiving an access request from said host computer; and
disconnecting said second switch circuit from said fourth switch circuit.

17. A disk subsystem controlling method according to claim 16, wherein the step of disconnecting said second switch circuit from said fourth switch circuit includes the steps of:
causing said second switch circuit and said fourth switch circuit to stop input/output of signals to/from said plurality of first and second memory devices;
causing said second switch circuit and said fourth switch circuit to stop interchange signals therebetween; and
disconnecting said second switch circuit from said fourth switch circuit.

18. A disk subsystem controlling method according to claim 15, wherein the step of changing connection of said second switch circuit and said fourth switch circuit to connection of said fourth switch circuit and a fourth disk controller to be connected to said second cache switch includes the steps of:
connecting said fourth disk controller to said fourth switch circuit;
changing said control information; and
causing said second switch circuit and said fourth switch circuit to start interchanging signals to/from said plurality of first and second memory devices.

19. A disk subsystem controlling method according to claim 15, wherein the control information stored in said common memory has mounting status information and operating status information concerning said first and second disk controllers.

20. A disk subsystem controlling method according to claim 19 further comprising the steps of:
when said first disk controller is to be blocked, letting the operating status information of said first disk controller “blocked”;
when said third disk controller is to be connected, letting the mounting status information of said third disk controller “mounted” and its operating status information “normal”;
when said first disk controller is to be placed in usable condition, letting the operating status information of said first disk controller “normal”;
when said second disk controller is to be blocked, letting the operating status information of said second disk controller “blocked”;
when said fourth disk controller is connected, letting the mounting status information of said fourth disk controller “mounted” and its operating status information “normal”; and
when said second disk controller is to be placed in usable condition, letting the operating status information of said second disk controller “normal”.
